(19) United States
(12) Patent Application Publication
(10) Pub. No.: US 2008/0201668 A1
(43) Pub. Date: Aug. 21, 2008

(54) EMAIL COMMUNICATIONS SYSTEM PROVIDING ELECTRONIC FILE ATTACHMENT FOLDER HIERARCHY AND RELATED METHODS

(75) Inventor: Shaibal Roy, Kolkata (IN)

Correspondence Address: CHRISTOPHER F. REGAN, ESQUIRE;ALLEN, DYER, DOPPELT, MILBRATH & GILCHRIST, P.A., P.O. Box 3791, Orlando, FL, 32802-3791, US

(73) Assignee: TEAMON SYSTEMS, INC., Issaquah, WA (US)

(21) Appl. No.: 12/031,012

(22) Filed: Feb. 14, 2008

Related U.S. Application Data
(60) Provisional application No. 60/889,964, filed on Feb. 15, 2007.

(51) Int. Cl. G06F 3/048; G06F 15/16

(52) U.S. Cl. 715/854

(57) ABSTRACT

An email communications system for operating over a communications network may include an email server for sending and receiving electronic mail (email) messages via the communications network, where at least some of the received email messages include electronic file attachments. The system may further include a communications device comprising a display, a user input device, and a processor for communicating with the email server. The processor may also cooperate with the display and user input device for displaying an email folder hierarchy for user navigation of the received email messages, and for displaying an electronic file attachment folder hierarchy corresponding to the email folder hierarchy for navigating the electronic file attachments.

### RELATED APPLICATION

This application is based upon prior filed copending provisional application Ser. No. 60/889,964 filed Feb. 15, 2007, the entire subject matter of which is incorporated herein by reference in its entirety.

### FIELD OF THE INVENTION

The present invention relates to the field of communications systems, and, more particularly, to wireless electronic mail (email) communications systems and related methods.

### BACKGROUND OF THE INVENTION

Electronic mail (email) has become an integral part of business and personal communications. As such, many users have multiple email accounts for work and home use. Moreover, with the increased availability of mobile cellular and wireless local area network (LAN) devices that can send and receive emails, many users wirelessly access emails stored in source mailboxes of different email storage servers (e.g., corporate email storage server, Yahoo, Hotmail, AOL, etc.).

With the increasing popularity of email has come an ever increasing number of emails that users have to manage. Moreover, as email service providers continue to increase mailbox size allocation for users, it is possible for users to have potentially thousands of emails stored in various files of their email folder hierarchy. More particularly, an email folder hierarchy is a set of folders that is displayed for a user on a computer, wireless handheld device, etc., that allows the user to navigate emails stored in the various folders. Typical email folder hierarchies resemble a windows file folder browser, for example, and may include folders such as an inbox folder, trash folder, saved emails folder, sent items folder, etc. It can also become challenging to reconcile emails within numerous folders in an email folder hierarchy with the email server that sends/receives emails on behalf of the email client on a particular user's computer/handheld device.

U.S. patent application publication no. 2006/0155810 is directed to a method for managing emails in a mobile terminal of a mobile email system. The mobile email system includes an email system and an email server coupled to a static terminal and in wireless communication with the mobile terminal. The static terminal has a folder-based data storage structure for storing emails received by a user of the static terminal. The email server is also configured to provide the received emails to the mobile terminal. The mobile terminal locally duplicates at least a portion of the state terminal folder-based data storage structure. The user is able to manage emails sent to a single address using the static and the mobile terminal. At the mobile terminal, a command is input from the user to move an email from a first folder of the local storage folder structure to a second folder of the local storage structure. The method further includes deleting the email from the local storage of the mobile terminal responsive to the user move command. The method further includes sending the move command from the mobile terminal to the email server.

While such systems may be advantageous for reconciling emails between a wireless device and a server, another difficulty is how to manage the electronic file attachments that often accompany emails. At present, it is cumbersome for users to attempt to separately store such attachments, and then navigate though a file manager program to append a desired attachment to another email, for example. Accordingly, in some applications it may be desirable to provide additional functionality for storing and retrieving email attachments.

### BRIEF DESCRIPTION OF THE DRAWINGS

FIG. 1 is a schematic block diagram of an email system in accordance with one embodiment.

FIG. 2 is a schematic block diagram of an alternative embodiment of the email system of FIG. 1.

FIG. 3 is a schematic representation of an email folder hierarchy shown on the display of the device of FIG. 1.

FIGS. 4-6 are schematic representations of an electronic file attachment folder hierarchy corresponding to the email folder hierarchy of FIG. 3 and organized based upon a chronological order, subject, and sender, respectively.

FIG. 7 is a schematic representation of an email folder hierarchy shown on the display of the device of FIG. 2.

FIG. 8 is a schematic representation of an electronic file attachment folder hierarchy corresponding to the email folder hierarchy of FIG. 7.

FIG. 9 is a flow diagram illustrating email communications method aspects in accordance with an embodiment.

FIG. 10 is a schematic block diagram illustrating exemplary components of a mobile wireless communications device for use with the system of FIG. 2.

### DETAILED DESCRIPTION OF THE PREFERRED EMBODIMENTS

The present description is made with reference to the accompanying drawings, in which preferred embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicated similar elements in alternative embodiments.

Generally speaking, an email communications system for operating over a communications network is disclosed herein which may include an email server for sending and receiving electronic mail (email) messages via the communications network, where at least some of the received email messages include electronic file attachments. The system may further include a communications device comprising a display, a user input device, and a processor for communicating with the email server. The processor may also cooperate with the display and user input device for displaying an email folder hierarchy for user navigation of the received email messages, and for displaying an electronic file attachment folder hierarchy corresponding to the email folder hierarchy for navigating the electronic file attachments.

More particularly, the electronic file attachment hierarchy may include a corresponding electronic file attachment folder for each email message folder in the email folder hierarchy. Also, the processor may provide the electronic file attachment folder hierarchy responsive to a command from the user input device to attach an electronic file to an outgoing email message. By way of example, the processor may organize electronic file attachments within electronic file attachment folder hierarchy folders based upon a chronological order, senders of respective received email messages, subjects of respective received email messages, etc.

The communications device may be a mobile wireless communications device, for example. Moreover, the system may further include a wireless communications network, and the email server and the processor may communicate via the wireless communications network. Furthermore, the email server may store the electronic file attachments not based upon the electronic file attachment hierarchy. As such, the system may further include a proxy server for relaying email messages and electronic file attachments between the email server, and for generating the electronic file attachment folder hierarchy for the processor. More particularly, the proxy server may include a WedDAV proxy module for generating the electronic file attachment folder hierarchy.

An email communications method aspect may include using an email server to send and receive electronic mail (email) messages via a communications network, where at least some of the received emails have electronic file attachments. The method may further include displaying an email folder hierarchy for user navigation of the received email messages on a display of a communications device, and displaying an electronic file attachment folder hierarchy on the display corresponding to the email folder hierarchy for navigating the electronic file attachments.

A computer-readable medium may have computer-executable instructions for causing a communications device to perform steps including communicating with an email server for sending and receiving electronic mail (email) messages via a communications network, where at least some of the received emails comprising electronic file attachments. The steps may further include displaying an email folder hierarchy for user navigation of the received email messages, and displaying an electronic file attachment folder hierarchy corresponding to the email folder hierarchy for navigating the electronic file attachments.

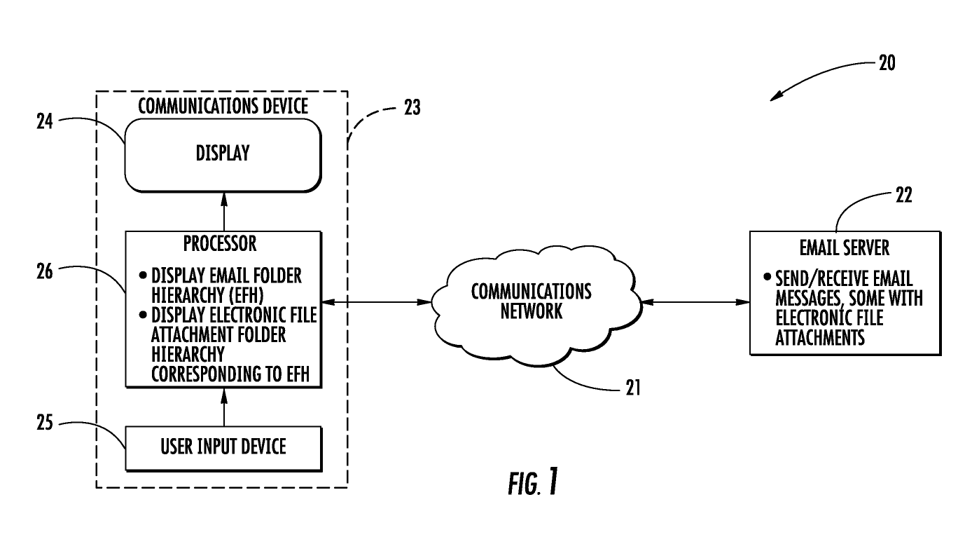

Referring initially to FIG. 1, an email communications system 20 is for operating over a communications network 21, which may be a Local Area Network (LAN), the Internet/World Wide Web, etc. The system 20 illustratively includes an email server 22 for sending and receiving email messages via the communications network 21. More particularly, depending upon the given implementation, the email messages may be sent to or received from other communications devices/email servers over the communications network 21, as will be appreciated by those skilled in the art.

The system 20 further illustratively includes a communications device 23 including a display 24, a user input device 25, and a processor 26 for communicating with the email server 22 via the communications network 21. By way of example, the communications device 23 may be a computer (e.g., personal computer (PC), Mac, etc.), as well as a wireless communications device such as a personal digital assistant (PDA) or a cellular phone with email capabilities, as will be discussed further below, although other suitable device may be used as well. The user input device 25 may thus include one or more of a keypad/keyboard, mouse, trackball, scroll wheel, stylus for a touch screen, etc., as will be appreciated by those skilled in the art. The processor 26 may include both hardware and software components, e.g., a microprocessor and accompanying operating system/email client application software, for example.

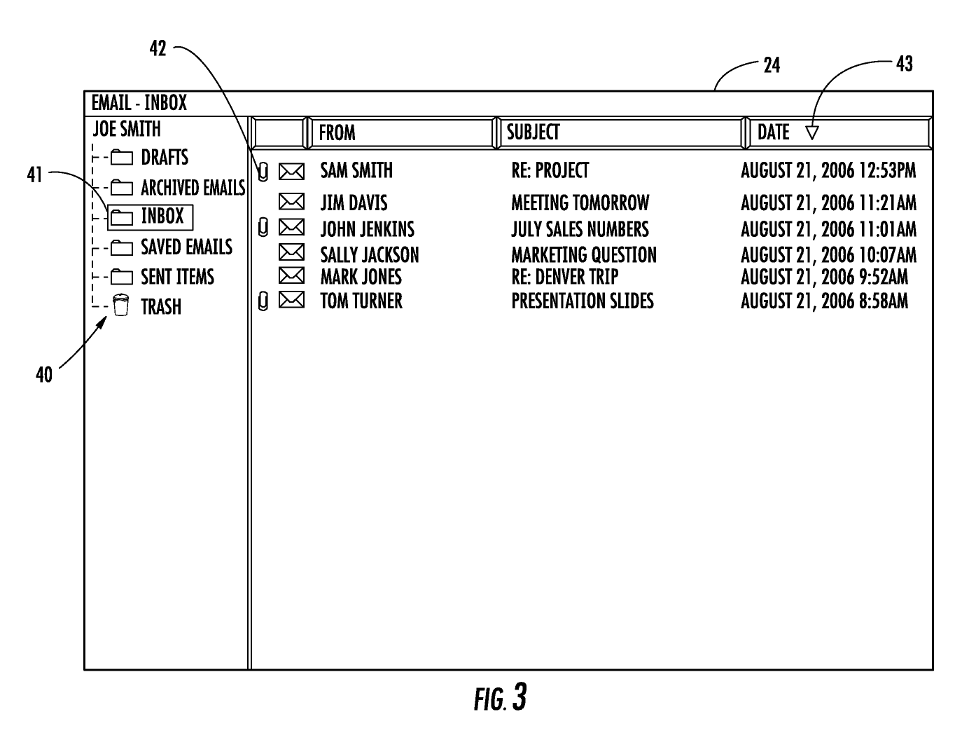

As will also be appreciated by those skilled in the art, many email messages are often accompanied by electronic file attachments. It is relatively easy for a user to organize/store emails using an email folder hierarchy 40, as seen in FIG. 3. In the illustrated example, the email folder hierarchy 40 includes the following email message folders: drafts; archived emails; inbox; saved emails; sent items; and trash. Of course, it will be appreciated that different email folders may be used in different embodiments.

Yet, organization and storage is generally more cumbersome with respect to electronic file attachments. That is, a user typically has to select or open the attachment from the corresponding email, and then choose to save the file in a designated directory, such as on a local c:\drive on a computer. If the user wants to then attach the file to an outgoing email, the user then has to select the attach file option from the email client application (e.g., MS Outlook, GroupWise, Eudora, etc.), and navigate though a folder hierarchy for the disk drive until the file attachment is located. This may be particularly difficult if the user waits some time before performing the operation, as the particular directory a given attachment is stored in may be forgotten. Moreover, the attachment may have a name that is unintuitive to the user, making it difficult for the user to recognize the desired file from others in the directory without opening one or more file, and without the context of the email from which it came.

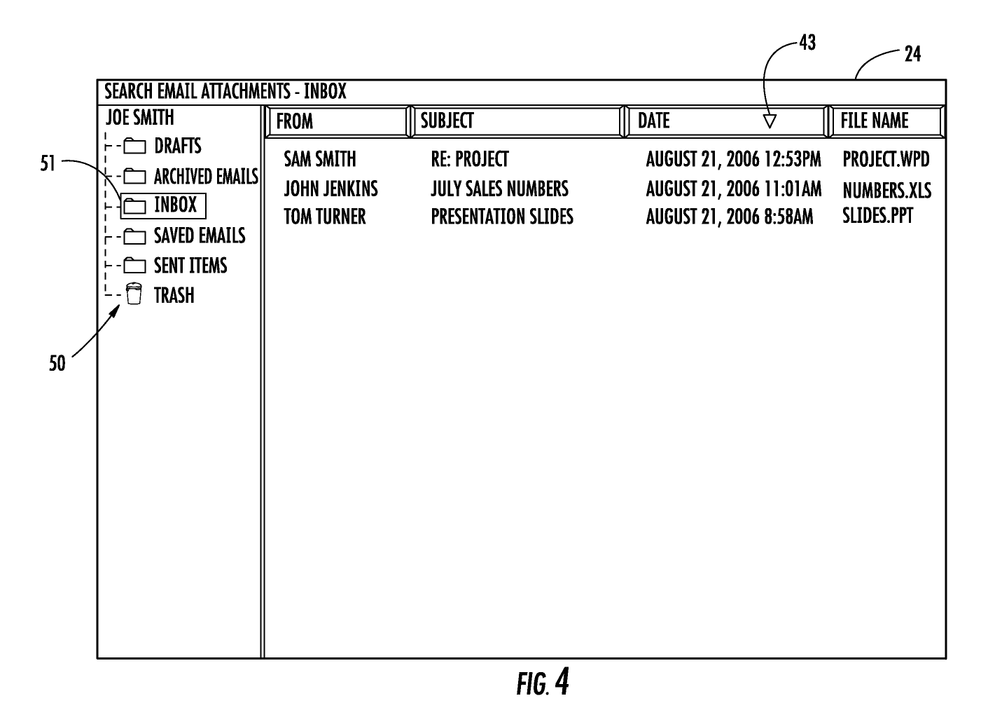

Referring now additionally to FIGS. 4-6, the processor 26 may not only cooperate with the display 24 and user input device 25 for displaying the email folder hierarchy 40 for user navigation of the received email messages, as noted above, but it may also advantageously cooperate with the display and user input device for displaying an electronic file attachment folder hierarchy 50 corresponding to the email folder hierarchy for navigating the electronic file attachments. That is, in the present example the electronic file attachment folder hierarchy 50 includes a corresponding electronic file attachment folder for each email message folder in the email folder hierarchy 40 (i.e., a drafts folder, archived emails folder, inbox folder, saved emails folder, sent items folder, and trash folder).

However, rather than displaying all of the emails messages present in the corresponding email folder hierarchy 40 folder, in the electronic file attachment folder hierarchy 50 only references to messages having file attachments are shown. In the example illustrated in FIGS. 3-6, the inbox folder is selected, as indicated by the highlight boxes 41, 51. The inbox folder of the email folder hierarchy 40 has six email messages stored therein, only three of which have electronic file attachments, as indicated by the paperclip icons 42 (FIG. 3). Yet, in the corresponding inbox folder of the electronic file attachment folder hierarchy 50 only the three emails from the email message inbox that have attachments are displayed. In the illustrated example, the name of the attachment is also displayed adjacent the corresponding sender/subject/date received data for the given email.

It should be noted that the email messages may include one or more attachments, all of which may be displayed in the email folder hierarchy 40. For example, MIME standards permit each message to contain multiple attachments, as well as other messages. Accordingly, in some embodiments each message in an email folder may correspond to a folder in the attachment hierarchy, as opposed to a single file. That is, the attachment hierarchy may be one level deeper than the email hierarchy and include one or more attachments and/or attached messages, as will be appreciated by those skilled in the art.

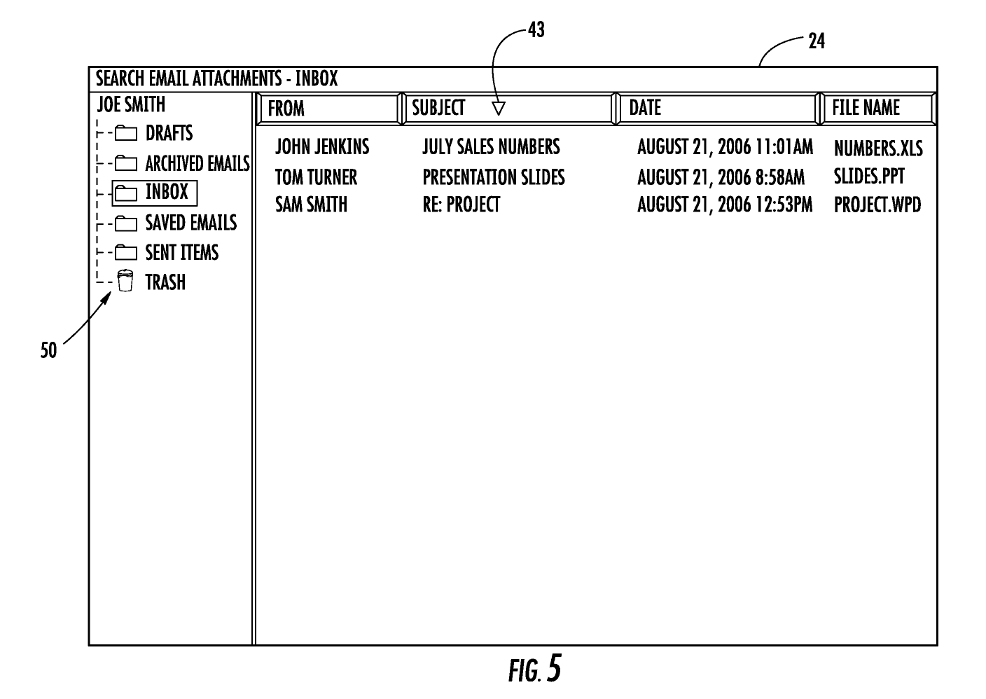

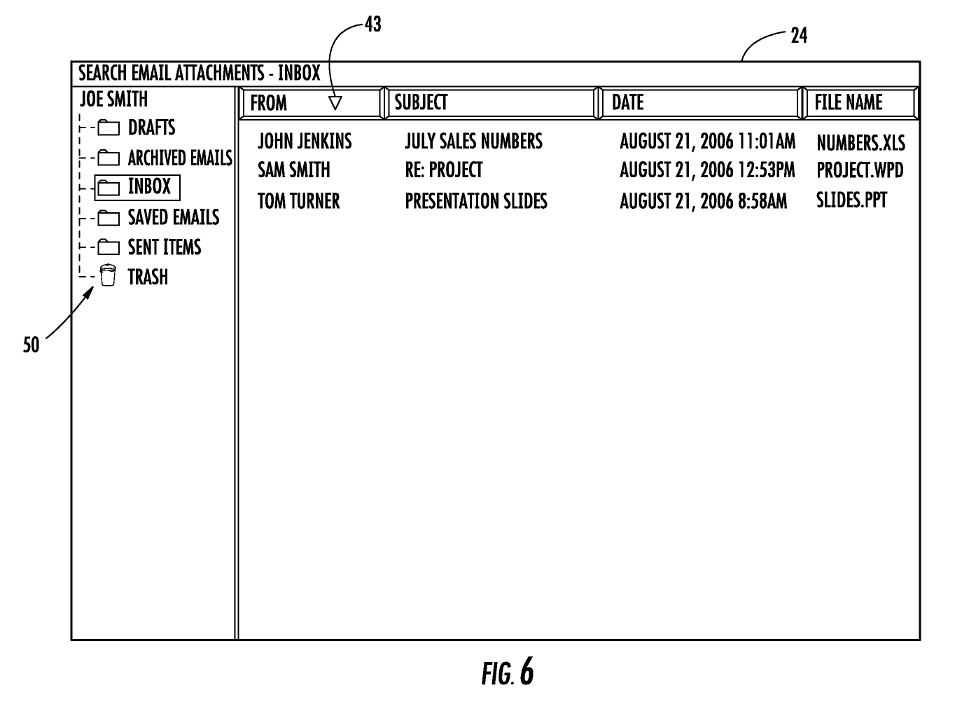

The processor 26 may organize electronic file attachments within electronic file attachment folder hierarchy 50 folders based upon a chronological order (i.e., received date), senders of respective received email messages, and subjects of respective received email messages, for example. For example, in FIG. 4 the attachments are arranged in a chronological order based upon the receipt date of their corresponding emails from most recent (top) to first received (bottom), as evidenced by the downward pointing triangle icon 43 (although other indicators or order selection approaches could be used). In FIG. 5, the attachments are arranged in alphabetical order by subject of the corresponding emails from top to bottom, and in FIG. 6 they are arranged in alphabetical order by sender name from top to bottom. The arrangement order may be user-selectable by clicking on the column headings (From, Subject, Date), as is common with email client application interfaces. Moreover, a reverse alphabetical or chronological order (i.e., bottom to top) may also be used. Additionally, other arrangements/ordering are also possible, such as alphabetically by name of the file attachment.

The user may wish to navigate electronic file attachments for a variety of reasons. In many cases, a user may wish to forward a received electronic file attachment to another user, but without the original message that accompanied the attachment. As such, in some embodiments the processor 26 may advantageously cause the electronic file attachment folder hierarchy 50 to be displayed responsive to a command from the user input device 25 via the email client application interface to attach an electronic file to an outgoing email message. More particularly, the email client application interface could provide a button or menu selection option to attach a file to an outgoing email message. There may be separate options for attaching a file using the electronic file attachment folder hierarchy 50, as well as from a typical windows-style directory browser (e.g., c: drive, etc.). Alternatively, the attach file option may invoke a windows-style directory browser but with the addition of a separate email attachments folder, which when selected or “drilled down”on by the user will display the full electronic file attachment folder hierarchy 50 for further navigation, as will be appreciated by those skilled in the art.

Users may also wish to access electronic file attachments to perform other operations. The processor 26 may advantageously allow the user to navigate the electronic file attachments and then perform traditional windows-type operations, such as dragging and dropping the attachment to a printer icon, a disk/zip drive, etc.

In addition, the processor 26 may also add or remove references to electronic file attachments as the corresponding emails are deleted or moved between different email folder hierarchy folders. For example, if a user moved an email message with an attachment from the inbox folder to the trash folder of the email folder hierarchy 40, the then trash folder of the corresponding electronic file attachment hierarchy 50 would then display the attachment (and the electronic file attachment inbox folder would not). In other words, the processor 26 preferably updates the folders and attachments shown in the electronic file attachment hierarchy 50 accordingly based upon changes in the email folder hierarchy 40.

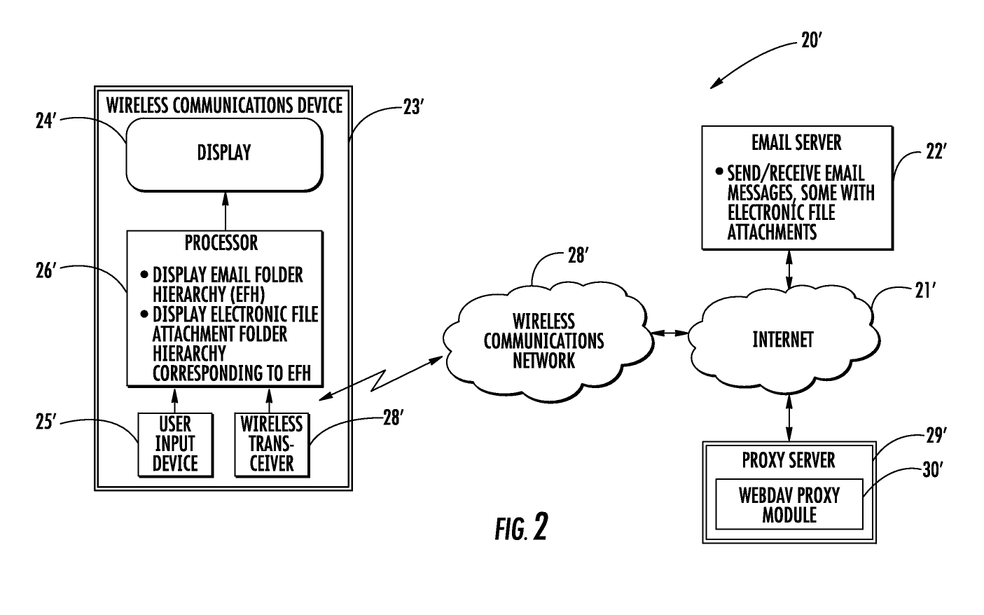

Turning now to FIG. 2, an alternative embodiment of the system 20′ illustratively includes a mobile wireless communications device 23′, such as a cellular or wireless local area network (LAN) device with email capability. Moreover, the system 20′ further illustratively includes a wireless communications network 28′ (e.g., cellular network, wireless LAN, etc.), and the mobile wireless communications device 23′ also includes a wireless transceiver 28′ and associated antenna (not shown) for communicating with the wireless communications network, as will be appreciated by those skilled in the art. In addition, in the present example the communications network 21′ is the Internet, and the wireless communications network 28F and the email server 22′ communicate thereover.

In such an arrangement, the email server 22′ may be part a corporate or Internet Service Provider (ISP) (e.g., Google, Hotmail, AOL, etc.) system. A proxy server 29′ may be used to forward or relay email messages from one or more email servers 22′ to a given wireless communications device 23′, as will be appreciated by those skilled in the art. For example, the proxy server 29′ may include a mail user agent (MUA) for this purpose. More particularly, a MUA is an application which uses a technique called polling to relay messages from the email server(s) 22′ to the email client application at a user's computer or mobile wireless communications device. While a MUA may run on a user's personal computing device (mobile or stationary) in some embodiments, in the illustrated example it is on the shared proxy server 29′ that may advantageously check for new email messages on behalf of a multitude of such users. More particularly, polling is the retrieval of incoming messages from other users at the email server 22′ and delivery of these messages to a designated user mailbox and/or the wireless communications device 23′.

Due to the relatively limited bandwidth of cellular communications links compared with land lines, as well as the relatively limited processing/memory capacity of mobile handheld wireless communications devices relative to desktop/laptop computers, the proxy server 29′ will typically not forward email attachments to the wireless communications device 23′ unless specifically requested by the user. Yet, common email server platforms (e.g., IMAP, Exchange, Notes, etc.) typically store electronic file attachments in a common directory, and not based upon based upon the electronic file attachment hierarchy 50. As such, in the illustrated configuration it may be difficult for the email client application on the wireless communications device 23′ to otherwise associate file attachments with an electronic file attachment folder hierarchy 50 that corresponds to the email folder hierarchy 40.

To this end, the proxy server 29′ may advantageously include an optional proxy module, such as a World Wide Web Distributed Authoring and Versioning (WebDAV) module, that provides an interface between the various email server platforms and email client applications. The WebDAV proxy module may advantageously obtain the requisite email message and attachment property information (last modified, size, etc.), such as with a GET PROP command, and generate the electronic file attachment folder hierarchy 50 for the wireless communications device 23′ based thereon, as will be appreciated by those skilled in the art.

In some applications, the WebDAV module 30′ may advantageously provide electronic file attachment folder hierarchy 50 information only at the current level at which the user is navigating. That is, rather than uploading the entire electronic file attachment folder hierarchy 50 to the user's device every time a file attachment request, etc. is made by the user, the WebDAV module 30′ may selectively provide this information in stages to conserve communications bandwidth, since the user may only be interested in navigating a single top-level folder, for example. It should be noted that other types of proxy modules and platforms could be used, such as a file system interface, or Windows NT or LINUX based interface, for example.

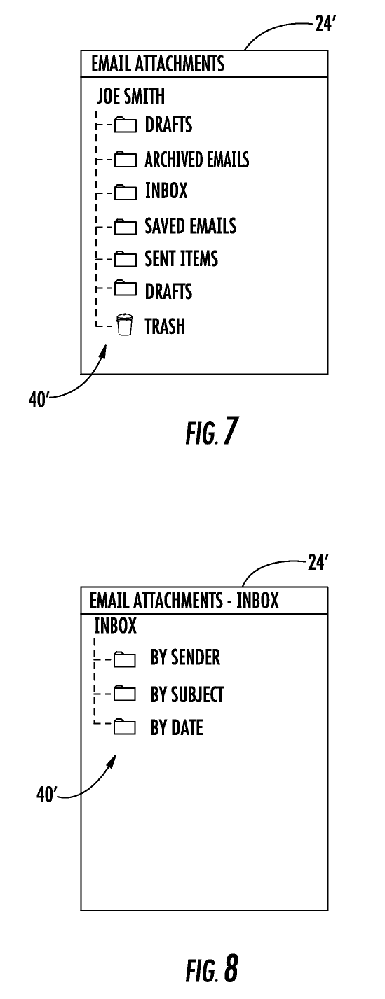

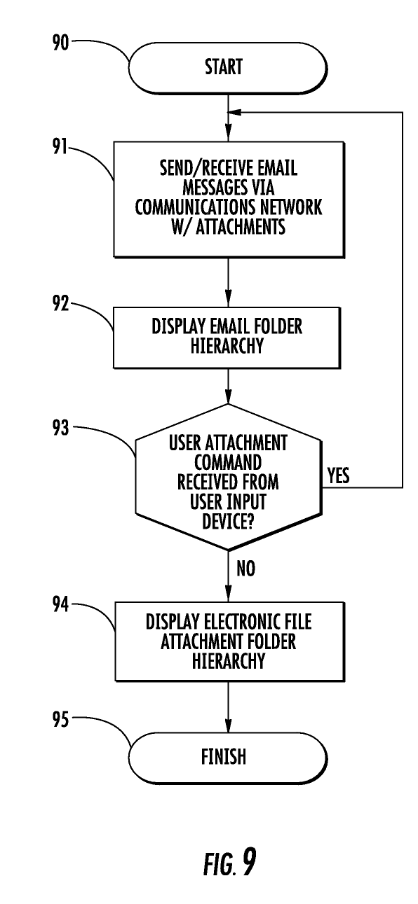

In the case of a wireless communications device display 24′, the reduced size of the display as compared to a desktop/laptop display may make a different email client application interface more appropriate. An exemplary email folder hierarchy 41′ for the wireless communications device display 24′ is shown in FIG. 7, and a corresponding exemplary electronic file attachment folder hierarchy 50′ is shown in FIG. 8. Here, rather than providing a multi-column screen as in FIGS. 3-6, just the electronic file attachment folder hierarchy 50′ is shown initially. Then, when a user selects or drills down on a particular folder (the inbox folder in the present example), three sub-folders are displayed which correspond to chronological (“By Date”), subject (“By Subject”), and sender (“By Sender”) organization. When a user selects/drills down on one of these sub-folders, a list of attachments and associated email message information is displayed in the selected organization order (i.e., chronological, subject, or sender order), as in FIGS. 4-6 above. Other arrangements are also possible.

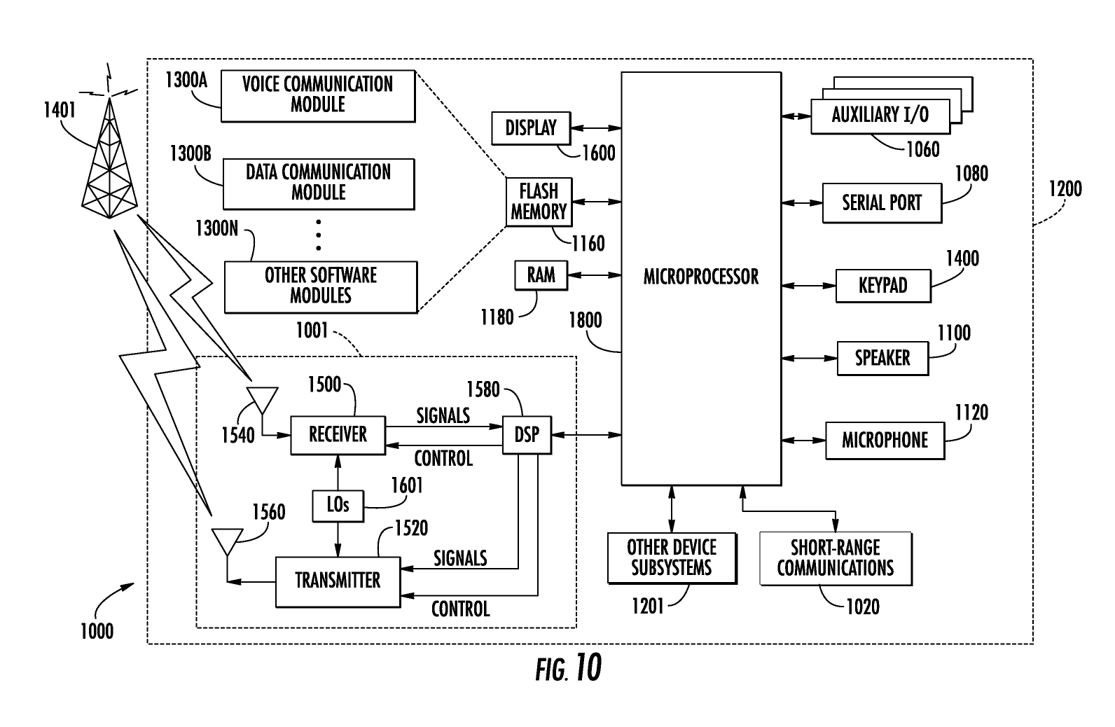

An email communications method aspect is now described with reference to FIG. 9. Beginning at Block 90, the method illustratively includes using the email server 22 to send and receive electronic mail (email) messages via the communications network 21, where at least some of the received emails have electronic file attachments, at Block 91. The method further illustratively includes displaying an email folder hierarchy 40 for user navigation of the received email messages on the display 24 of the communications device 23, at Block 93, and displaying an electronic file attachment folder hierarchy 50 on the display corresponding to the email folder hierarchy for navigating the electronic file attachments, at Block 94, thus concluding the illustrated method (Block 95). As noted above, the electronic file attachment folder hierarchy 50 may be displayed responsive to a command from the user input device 25 to attach an electronic file to an outgoing email message, for example, at Block 93.

One example of a hand-held mobile wireless communications device 1000 that may be used in accordance the system 20 is further described in the example below with reference to FIG. 10. The device 1000 illustratively includes a housing 1200, a keypad 1400 and an output device 1600. The output device shown is a display 1600, which is preferably a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 10. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 is preferably a two-way RF communications device having voice and data communications capabilities. In addition, the mobile device 1000 preferably has the capability to communicate with other computer systems via the Internet.

Operating system software executed by the processing device 1800 is preferably stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 13003, may be installed on the device 1000 during manufacture. In addition, a personal information manager (PIM) application may be installed during manufacture. The PIM is preferably capable of organizing and managing data items, such as e-mail, calendar events, voice mails, appointments, and task items. The PIM application is also preferably capable of sending and receiving data items via a wireless network 1401. Preferably, the PIM data items are seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, PCS, GSM, etc. Other types of data and voice networks, both separate and integrated, may also be utilized with the mobile device 1000.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. An email communications system for operating over a communications network, the email communications system comprising:
an email server for sending and receiving electronic mail (email) messages via the communications network, at least some of the received email messages comprising electronic file attachments; and
a communications device comprising
a display,
a user input device, and
a processor for communicating with said email server and cooperating with said display and user input device for displaying an email folder hierarchy for user navigation of the received email messages, and for displaying an electronic file attachment folder hierarchy corresponding to the email folder hierarchy for navigating the electronic file attachments.

2. The email communications system of claim 1 wherein the electronic file attachment folder hierarchy comprises a corresponding electronic file attachment folder for each email message folder in the email folder hierarchy.

3. The email communications system of claim 1 wherein said processor displays the electronic file attachment folder hierarchy responsive to a command from said user input device to attach an electronic file to an outgoing email message.

4. The email communications system of claim 1 wherein said processor organizes electronic file attachments within electronic file attachment folder hierarchy folders based upon a chronological order.

5. The email communications system of claim 1 wherein said processor organizes electronic file attachments within electronic file attachment folder hierarchy folders based upon senders of respective received email messages.

6. The email communications system of claim 1 wherein said processor organizes electronic file attachments within electronic file attachment folder hierarchy folders based upon subjects of respective received email messages.

7. The email communications system of claim 1 wherein said communications device comprises a mobile wireless communications device.

8. The email communications system of claim 7 further comprising a wireless communications network, and wherein said email server and said processor communicate via said wireless communications network.

9. The email communications system of claim 1 wherein said email server stores the electronic file attachments not based upon the electronic file attachment hierarchy; and further comprising a proxy server for relaying email messages and electronic file attachments between said email server and generating the electronic file attachment folder hierarchy for said processor.

10. The email communications system of claim 10 wherein said proxy server comprises a WedDAV proxy module for generating the electronic file attachment folder hierarchy.

11. A communications device for communicating with an email server over a communications network, the email server for sending and receiving electronic mail (email) messages via the communications network, and at least some of the received email messages comprising electronic file attachments, the communications device comprising:
a display;
a user input device; and
a processor for communicating with the email server and cooperating with said display and user input device for displaying an email folder hierarchy for user navigation of the received email messages, and for displaying an electronic file attachment folder hierarchy corresponding to the email folder hierarchy for navigating the electronic file attachments.

12. The communications device of claim 11 wherein the electronic file attachment folder hierarchy comprises a corresponding electronic file attachment folder for each email message folder in the email folder hierarchy.

13. The communications device of claim 11 wherein said processor displays the electronic file attachment folder hierarchy responsive to a command from said user input device to attach an electronic file to an outgoing email message.

14. The communications device of claim 11 wherein said processor organizes electronic file attachments within electronic file attachment folder hierarchy folders based upon at least one of a chronological order, senders of respective received email messages, and subjects of respective received email messages.

15. An email communications method comprising:
using an email server to send and receive electronic mail (email) messages via a communications network, at least some of the received email messages comprising electronic file attachments;
displaying an email folder hierarchy for user navigation of the received email messages on a display of a communications device; and
displaying an electronic file attachment folder hierarchy on the display corresponding to the email folder hierarchy for navigating the electronic file attachments.

16. The method of claim 15 wherein the electronic file attachment folder hierarchy comprises a corresponding electronic file attachment folder for each email message folder in the email folder hierarchy.

17. The method of claim 15 wherein displaying the electronic file attachment folder hierarchy comprises displaying the electronic file attachment folder hierarchy responsive to a command from a user input device of the communications device to attach an electronic file to an outgoing email message.

18. The method of claim 15 further comprising organizing electronic file attachments within electronic file attachment folder hierarchy folders based upon a chronological order.

19. The method of claim 15 further comprising organizing electronic file attachments within electronic file attachment folder hierarchy folders based upon senders of respective received email messages.

20. The method of claim 15 further comprising organizing electronic file attachments within electronic file attachment folder hierarchy folders based upon based upon subjects of respective received email messages.

21. The method of claim 15 wherein the communications device comprises a mobile wireless communications device.

22. A computer-readable medium having computer-executable instructions for causing a communications device to perform steps comprising:
communicating with an email server for sending and receiving electronic mail (email) messages via a communications network, at least some of the received emails comprising electronic file attachments;
displaying an email folder hierarchy for user navigation of the received email messages; and
displaying an electronic file attachment folder hierarchy corresponding to the email folder hierarchy for navigating the electronic file attachments.

23. The computer-readable medium of claim 23 wherein the electronic file attachment folder hierarchy comprises a corresponding electronic file attachment folder for each email message folder in the email folder hierarchy.

24. The computer-readable medium of claim 23 wherein displaying the electronic file attachment folder hierarchy comprises displaying the electronic file attachment folder hierarchy responsive to a command from a user input device of the communications device to attach an electronic file to an outgoing email message.

25. The computer-readable medium of claim 23 further comprising computer-executable instructions for performing a step of organizing electronic file attachments within electronic file attachment folder hierarchy folders based upon at least one of a chronological order, senders of respective received email messages, and subjects of respective received email messages.

26. The computer-readable medium of claim 23 wherein the communications device comprises a mobile wireless communications device.
